(19) United States
(12) Patent Application Publication
(10) Pub. No.: US 2011/0264352 A1
(43) Pub. Date: Oct. 27, 2011

(54) METHOD AND DEVICE FOR OPERATING AN INTERNAL COMBUSTION ENGINE OF A MOTOR VEHICLE

(76) Inventors: Peter Bauer, Immenreuth (DE); Tahar Zrilli, Regensburg (DE)

(21) Appl. No.: 12/673,527

(22) PCT Filed: Jul. 30, 2008
(86) PCT No.: PCT/EP2008/060008

§ 371 Date: Jul. 11, 2011

(30) Foreign Application Priority Data
Aug. 14, 2007 (DE) 10 2007 038 411.6

(51) Int. Cl. F01N 9/00; F02D 28/00

(52) U.S. Cl. 701/102

(57) ABSTRACT

To operate an internal combustion engine of a motor vehicle, during a plurality of driving cycles of the motor vehicle at least one operating variable is recorded during each run which is representative of a harmful substance content of an exhaust gas of the internal combustion engine. The recorded runs are analyzed with respect to recurring run patterns. In a current driving cycle of the motor vehicle, a target value of an ammonia charge level of an exhaust gas catalyst of the internal combustion engine is determined using the recurring run pattern, depending on which, at least one actuating signal for an actuator is determined, the position of which affects an actual ammonia charge level of the exhaust gas catalyst. In order to convert the determined target value of the ammonia charge level of the exhaust gas catalyst, the actuator is controlled as a function of the actuating signal.

### CROSS-REFERENCE TO RELATED APPLICATIONS

This application is a U.S. National Stage Application of International Application No. PCT/EP2008/060008 filed Jul. 30, 2008, which designates the United States of America, and claims priority to German Application No. 10 2007 038 411.6 filed Aug. 14, 2007, the contents of which are hereby incorporated by reference in their entirety.

### TECHNICAL FIELD

The invention relates to a method and an apparatus for operating an internal combustion engine of a motor vehicle. For this purpose, during a plurality of travelling cycles of the motor vehicle in each case one characteristic of at least one operating variable that is representative of a noxious substance content of an exhaust gas of the internal combustion engine is logged.

### BACKGROUND

To reduce a noxious substance content in the exhaust gas of an internal combustion engine an exhaust gas after-treatment may be carried out with a reducing agent. The noxious substance content comprises for example a nitrous oxide content of the exhaust gas. The reducing agent comprises for example an aqueous urea solution and/or a complex salt. The exhaust gas after-treatment is carried out at least partially in an exhaust gas catalytic converter, in particular a selective catalytic reduction converter (SCR converter). The aqueous urea solution may also be referred to as urea. For the exhaust gas after-treatment the aqueous urea solution is pumped by a liquid pump to a urea injection valve, which upstream of the exhaust gas catalytic converter meters the urea solution into an exhaust gas flow in an exhaust gas tract of the internal combustion engine. The urea solution reacts in the hot exhaust gas flow to form ammonia and carbon dioxide. The complex salt releases gaseous ammonia depending upon its temperature. In the exhaust gas catalytic converter the ammonia then reacts with the nitrous oxide mixture of the exhaust gas to form nitrogen and water.

### SUMMARY

According to various embodiments, a method and an apparatus for operating an internal combustion engine can be provided, which enable a particularly effective exhaust gas after-treatment of an exhaust gas of the internal combustion engine by means of an exhaust gas after-treatment system.

According to an embodiment, in a method of operating an internal combustion engine of a motor vehicle, during a plurality of driving cycles of the motor vehicle:—in each case one run of at least one operating variable of the internal combustion engine that is representative of a noxious substance content of an exhaust gas of the internal combustion engine is logged,—the logged runs are analyzed with regard to recurring run patters, and during an actual driving cycle of the motor vehicle:—using the recurring run patterns a setpoint value of a degree of ammonia loading of an exhaust gas catalytic converter of the internal combustion engine is determined,—depending upon the determined setpoint value of the degree of ammonia loading at least one actuating signal is determined for an actuator, the position of which affects an actual degree of ammonia loading of the exhaust gas catalytic converter,—to convert the determined setpoint value of the degree of ammonia loading of the exhaust gas catalytic converter the actuator is controlled depending upon the actuating signal.

According to a further embodiment, the recurring run patterns can be used during determination of the setpoint value of the degree of ammonia loading only if a frequency, with which the corresponding recurring run patterns occur in each case in the logged runs, is greater than a preset threshold value. According to a further embodiment, during the actual driving cycle of the motor vehicle the setpoint value of the degree of ammonia loading of the exhaust gas catalytic converter can be determined using the recurring run patterns in that an actual run of the operating variable is determined, using the recurring run patterns and depending upon the determined actual run of the operating variable a trend, with which the noxious substance content of the exhaust gas is expected to vary, is determined, depending upon the determined trend the setpoint value of the degree of ammonia loading of the exhaust gas catalytic converter is determined and converted. According to a further embodiment, the setpoint value of the degree of ammonia loading of the exhaust gas catalytic converter can be determined and converted in such a way that after conversion of the setpoint value of the degree of ammonia loading of the exhaust gas catalytic converter the exhaust gas catalytic converter is loaded in such a way with ammonia that the nitrous oxides then contained in the exhaust gas may be transformed with the ammonia. According to a further embodiment, the trend can be evaluated with a probability value that is representative of the probability that an actual run of the noxious substance content of the exhaust gas will follow the determined trend, and wherein the setpoint value of the degree of ammonia loading of the exhaust gas catalytic converter is determined depending upon the determined trend only if the probability value is greater than a preset second threshold value.

According to another embodiment, an apparatus for operating an internal combustion engine of a motor vehicle, can be designed, during a plurality of driving cycles of the motor vehicle,—to log in each case one run of at least one operating variable of the internal combustion engine that is representative of a noxious substance content of an exhaust gas of the internal combustion engine,—to analyze the logged runs with regard to recurring run patterns, and during an actual driving cycle of the motor vehicle:—using the recurring run patterns, to determine a setpoint value of a degree of ammonia loading of an exhaust gas catalytic converter of the internal combustion engine,—depending upon the determined setpoint value of the degree of ammonia loading, to determine at least one actuating signal for an actuator, the position of which affects an actual degree of ammonia loading of the exhaust gas catalytic converter,—to control the actuator depending upon the actuating signal in order to convert the determined setpoint value of the degree of ammonia loading of the exhaust gas catalytic converter.

### BRIEF DESCRIPTION OF THE DRAWINGS

There now follows a detailed description of embodiments with reference to diagrammatic drawings.

The drawings show:

FIG. 1 an internal combustion engine,

FIG. 2 an exhaust gas after-treatment system of the internal combustion engine,

FIG. 3 a flowchart of a first program for operating the internal combustion engine,

FIG. 4 a flowchart of a second program for operating the internal combustion engine.

In all of the figures, elements of an identical construction or function are denoted by the same reference characters.

### DETAILED DESCRIPTION

According to various embodiments, during a plurality of driving cycles of the motor vehicle in each case one run of at least one operating variable of the internal combustion engine is logged. The operating variable is representative of a noxious substance content of an exhaust gas of the internal combustion engine. The logged runs are analyzed for recurring run patterns. During an actual driving cycle of the motor vehicle, using the recurring run patterns a setpoint value of a degree of ammonia loading of an exhaust gas catalytic converter of the internal combustion engine is determined.

Depending upon the determined setpoint value of the degree of ammonia loading at least one actuating signal for an actuator is determined. A position of the actuator affects an actual degree of ammonia loading of the exhaust gas catalytic converter. To convert the determined setpoint value of the degree of ammonia loading of the exhaust gas catalytic converter the actuator is controlled depending upon the determined actuating signal.

This makes it possible to adjust the degree of ammonia loading of the exhaust gas catalytic converter in advance to a varying noxious substance content of the exhaust gas. It is therefore possible to avoid both a nitrous oxide breakthrough and an ammonia breakthrough of the exhaust gas catalytic converter. This contributes towards a particularly effective exhaust gas after-treatment of the exhaust gas of the internal combustion engine by means of an exhaust gas after-treatment system, in particular the exhaust gas catalytic converter. The operating variable of the internal combustion engine comprises for example a rotational speed, a torque, an exhaust gas temperature and/or a load of the internal combustion engine. The load of the internal combustion engine is characterized for example by an air-mass flow into the intake tract of the internal combustion engine or by an intake-manifold pressure in an intake manifold of the intake tract of the internal combustion engine. The exhaust gas catalytic converter comprises for example an SCR converter.

In this connection it is particularly advantageous if the recurring run patterns are taken into account during determination of the setpoint value of the degree of ammonia loading only if a frequency, with which the corresponding recurring run patterns occur in each case in the logged runs, is greater than a preset first threshold value. This is a simple way of helping to prevent the degree of ammonia loading from being adjusted unnecessarily to an estimated noxious substance content of the exhaust gas.

In an advantageous development, during the actual driving cycle of the motor vehicle the setpoint value of the degree of ammonia loading of the exhaust gas catalytic converter is determined using the recurring run patterns in that an actual run of the operating variable is determined. Using the recurring run patterns and depending upon the determined actual run of the operating variable a trend, with which the noxious substance content of the exhaust gas is expected to vary, is determined. Depending upon the determined trend the setpoint value of the degree of ammonia loading of the exhaust gas catalytic converter is determined and converted. This is a particularly easy way of preparing the degree of loading of the exhaust gas catalytic converter in good time for the varying noxious substance content of the exhaust gas. This moreover utilizes the knowledge that a defined driver of the motor vehicle basically travels the same routes again and again and also regularly exhibits an identical driving behavior. For example, a driver is basically an aggressive or a defensive driver. Furthermore, the driving behavior of a driver who travels mainly around town, for example a taxi driver, differs in principle from the driving behavior of a commuter. A further different driving behavior is exhibited for example by a sales representative who travels for example mainly on motorways. The anticipatory loading of the exhaust gas catalytic converter with ammonia is particularly advantageous for motor vehicles, the travel routes of which are consistently identical, for example scheduled service buses.

In a further advantageous development, the setpoint value of the degree of ammonia loading of the exhaust gas catalytic converter is determined and converted in such a way that after the conversion of the setpoint value of the degree of ammonia loading of the exhaust gas catalytic converter the exhaust gas catalytic converter is loaded in such a way with ammonia that the anticipated nitrous oxide content of the exhaust gas may be transformed by the ammonia. This contributes towards the particularly effective exhaust gas after-treatment by means of the exhaust gas after-treatment system as preferably all of the nitrous oxides of the exhaust gas are able to react with the ammonia, with which the exhaust gas catalytic converter is loaded, to form nitrogen and water.

In a further advantageous development, the trend is weighted with a probability value. The probability value is representative of the probability that an actual run of the noxious substance content of the exhaust gas will follow the determined trend. The setpoint value of the degree of ammonia loading of the exhaust gas catalytic converter is then determined depending upon determined trend only if the probability value is greater than a preset second threshold value. This is an easy way of preventing the degree of ammonia loading from being set unnecessarily to a preset degree of ammonia loading.

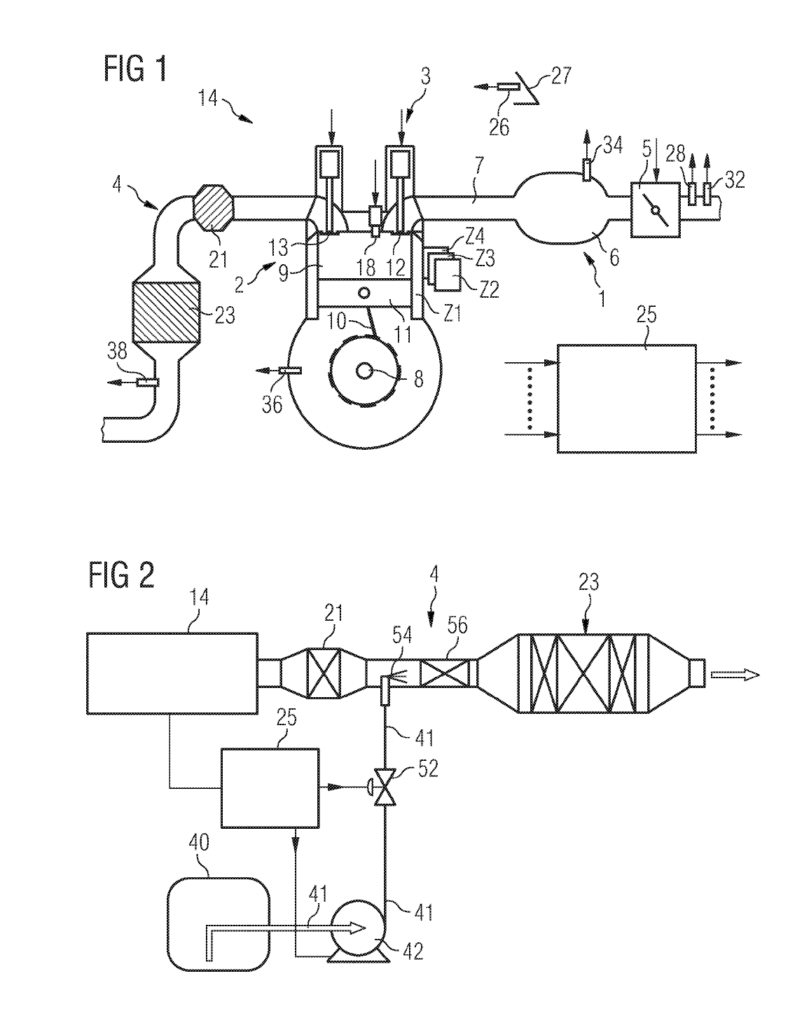

An internal combustion engine 14 (FIG. 1) comprises an intake tract 1, an engine block 2, a cylinder head 3 and an exhaust gas tract 4. The intake tract 1 preferably comprises a throttle valve 5, a collector 6 and an intake manifold 7 that extends in the direction of a cylinder Z1-Z4 through an inlet channel into a combustion chamber 9 of the engine block 2. The combustion chamber 9 communicates, depending on a position of a gas inlet valve 12 or of a gas outlet valve 13, with the intake tract 1 or with the exhaust gas tract 4. The engine block 2 comprises a crankshaft 8, which is coupled by a connecting rod 10 to a piston 11 of the cylinder Z1-Z4. The internal combustion engine 14 preferably comprises further cylinders Z1-Z4. The internal combustion engine 14 is disposed preferably in a motor vehicle.

A fuel injection valve 18 is preferably disposed in the cylinder head 3. Unless the internal combustion engine 14 is a diesel engine, there is preferably a spark plug associated with each cylinder Z1-Z4. Alternatively, the fuel injection valve 18 may be disposed in the intake manifold 7.

An exhaust gas after-treatment system is moreover preferably associated with the exhaust gas tract 4 (FIG. 2). The exhaust gas after-treatment system comprises for example an SCR system. The exhaust gas after-treatment system comprises a reducing agent tank for receiving a reducing agent, a reducing agent metering valve and preferably a reducing agent pump for supplying reducing agent from the reducing agent tank to the reducing agent metering valve.

The reducing agent tank preferably comprises a urea tank 40. The reducing agent metering valve preferably comprises a urea injection valve 54. The reducing agent pump preferably comprises a pump 42. The reducing agent preferably comprises urea. Alternatively or additionally the reducing agent may comprise a complex salt. The urea may be conveyed from the urea tank 40 through a urea line 41 by means of the pump 42 to the urea injection valve 54. The metering of the urea into the exhaust gas tract 4 may be controlled, in addition or alternatively to the urea injection valve 54, by means of a urea valve 52 at the urea line 41.

Upstream of the urea injection valve 54 a particulate filter 21 is preferably disposed. Disposed downstream of the urea injection valve 54 there is preferably a mixing apparatus 56 for mixing the metered urea, in particular the ammonia, with exhaust gas in the exhaust gas tract 4. An exhaust gas catalytic converter 23 is further disposed downstream of the mixing apparatus 56. In addition to the exhaust gas catalytic converter 23 a hydrolysis catalytic converter may be provided upstream of the exhaust gas catalytic converter 23 and downstream of the mixing apparatus 56, and an oxidation catalytic converter may be provided downstream of the exhaust gas catalytic converter 23. The exhaust gas catalytic converter preferably comprises an SCR converter.

If the internal combustion engine 14 is operated with a lean mixture and is therefore in lean-burn mode, during a combustion process of the internal combustion engine 14 less fuel is supplied to the combustion chamber 9 than may be burnt with the oxygen in the combustion chamber 9. This leads to—compared to a stoichiometric operation of the internal combustion engine 14—an increased formation of nitrous oxides, which are then contained in the exhaust gas. The nitrous oxides may react in the exhaust gas catalytic converter 23 with ammonia to form elementary nitrogen and water. For this reason, in a preferred manner the urea, from which the ammonia is produced in a chemical reaction, is metered by the urea injection valve 54 into the exhaust gas tract 4. The urea, in particular the ammonia, mixes mainly in the mixing apparatus 56 with the exhaust gas of the internal combustion engine 14. The urea may also be referred to as an aqueous urea solution.

A control device 25 is provided, with which are associated sensors that acquire various measured variables and determine in each case the value of the measured variable. The control device 25 determines depending upon at least one of the measured variables at least one manipulated variable, which manipulated variables are then converted into one or more actuating signals for controlling the actuators by means of corresponding actuating drives. The control device 25 may be described also as an apparatus for operating the internal combustion engine 14.

The sensors are for example a pedal position sensor 26 that acquires an accelerator pedal position of an accelerator pedal 27, an air-mass sensor 28 that acquires an air-mass flow upstream of the throttle valve 5, a temperature sensor 32 that acquires an intake air temperature, an intake manifold pressure sensor 34 that acquires an intake manifold pressure in the collector 6, a crankshaft angle sensor 36 that acquires a crankshaft angle, with which a rotational speed of the internal combustion engine 14 may then be associated, a reducing agent temperature sensor, in particular a urea temperature sensor 43 for acquiring a urea temperature of the urea in the urea tank 40. An exhaust gas probe 38 is further provided, which is disposed for example downstream of the exhaust gas catalytic converter 23 and acquires for example the noxious substance content, in particular a nitrous oxide content and/or a urea content of the exhaust gas.

Depending on the embodiment, any subset of the described sensors may be provided or additional sensors may also be provided.

The actuators are for example the throttle valve 5, the gas inlet—and gas outlet valves 12, 13, the fuel injection valve 18, the urea injection valve 54, the urea valve 52, the pump 42 and/or optionally the spark plug.

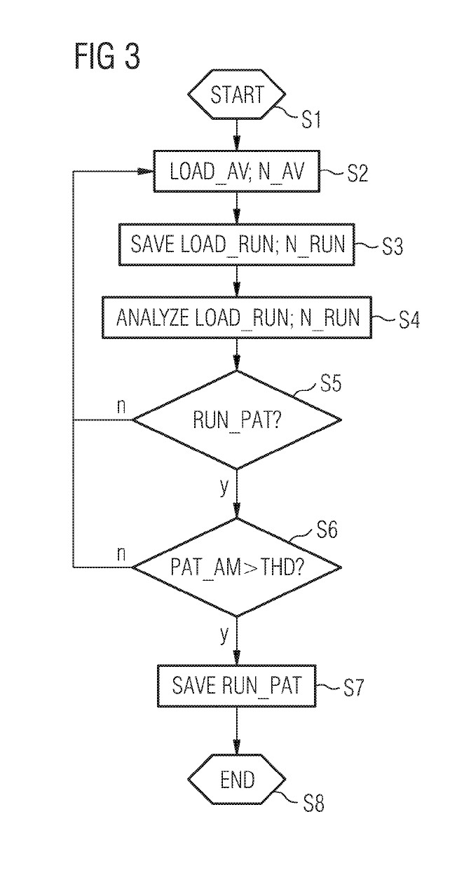

On a storage medium of the control device 25 a first program for operating the internal combustion engine 14 is preferably stored (FIG. 3). The first program is used to log a run of at least one of the operating variables that are representative of the noxious substance content of the exhaust gas of the internal combustion engine 14. The first program is further used to search for and optionally log recurring run patterns RUN_PAT in the logged runs of the operating variable. In other words, the first program is used to analyze the run of the operating variable with regard to the recurring run patterns RUN_PAT.

The first program is preferably started at a time close to a start of the internal combustion engine in a step S1, in which optionally variables are initialized.

In a step S2 a value of the operating variable of the internal combustion engine is determined. For example, an actual value LOAD_AV of a load or load variable of the internal combustion engine is determined or a value N_AV of the rotational speed of the internal combustion engine is determined. Alternatively or additionally, in this connection the intake manifold pressure and/or a combustion temperature of a combustion process of the internal combustion engine may be used as an operating variable.

In a step S3 by means of a memory instruction SAVE a run of the operating variable is stored. In particular, in step S3 a run LOAD_RUN of the load variable and/or a run N_RUN of the rotational speed of the internal combustion engine are stored.

In a step S4 by means of an analyze instruction ANALYZE the runs LOAD_RUN of the load variable and of the run N_RUN of the rotational speed of the internal combustion engine are analyzed with regard to the recurring run patterns RUN_PAT.

In a step S5 it is checked whether in the logged runs at least one, preferably a plurality of recurring run patterns RUN_PAT occur. For this purpose, a preset algorithm may for example analyze the runs with regard to occurring and recurring gradients. Steps S4 and S5 may moreover also be executed in one step.

In a step S6, preferably a number PAT_AM is determined, with which at least one of the run patterns RUN_PAT occurs in the logged runs of the operating variable. In particular in step S6 it is checked whether the number PAT_AM of the recurring run patterns RUN_PAT is greater than a preset threshold value THD. If the condition of step S6 is met, processing is continued in a step S7. If the condition of step S6 is not met, processing is continued afresh in step S2.

In a step S7 by means of the memory instruction SAVE at least one of the determined run patterns RUN_PAT is saved.

In a step S8 the first program for operating the internal combustion engine may be terminated. The first program is however preferably executed regularly during operation of the internal combustion engine.

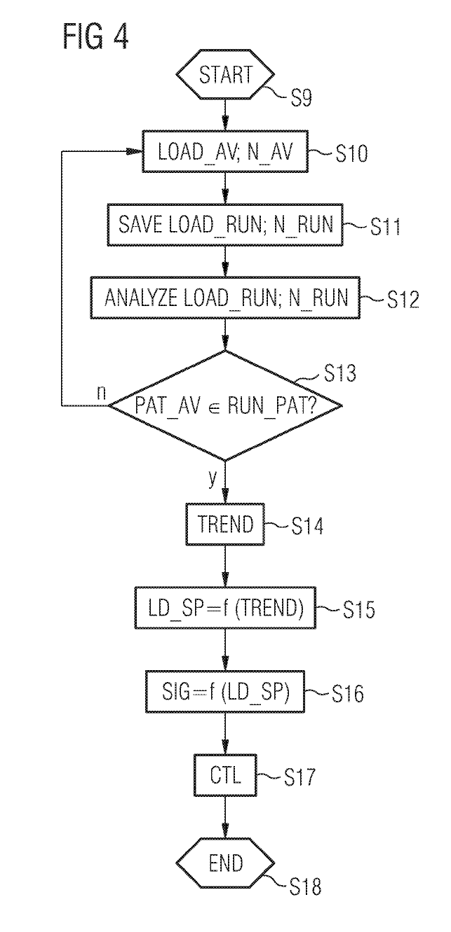

On the storage medium of the control device 25 a second program for operating the internal combustion engine is preferably stored (FIG. 4). The second program for operating the internal combustion engine is used during an actual driving cycle of the motor vehicle to log the operating variable and the run thereof and, using the logged runs of the operating variable and in particular the saved recurring run patterns RUN_PAT of the runs, to estimate an expected noxious substance content of the exhaust gas and as a function thereof preset a degree of ammonia loading of the exhaust gas catalytic converter 23 in such a way that preferably all of the nitrous oxides expected to be contained in the exhaust gas are able to react with the ammonia and no ammonia breakthrough of the exhaust gas catalytic converter 23 occurs.

The second program is started at a time close to the start of the internal combustion engine in a step S9, in which optionally variables are initialized.

Steps S10 to S12 of the second program are preferably executed in accordance with steps S2 to S4 of the first program.

In a step S13 it is checked whether an actual run pattern PAT_AV of the actually logged operating variable corresponds at least approximately to an already logged recurring run pattern RUN_PAT. If the condition of step S13 is met, processing is continued in a step S14. If the condition of step S13 is not met, processing is continued in a step S10.

In step S14 a trend TREND is determined, which is representative of how the noxious substance content of the exhaust gas is expected to vary imminently. Imminently in this context preferably means precisely as long as the adjustment of a preset degree of loading of the exhaust gas catalytic converter with ammonia takes for enough ammonia for the varying noxious substance content of the exhaust gas to be available in the exhaust gas catalytic converter 23 to transform the nitrous oxides. For example, in step S14 it may be determined that probably in a second an increasing noxious substance content of the exhaust gas is to be expected.

In a step S15, depending upon the determined trend TREND a setpoint value LD_SP of the degree of loading of the exhaust gas catalytic converter 23 is determined. For example, given the expected increase in the noxious substance content of the exhaust gas, the degree of ammonia loading may already be increased before the variation of the noxious substance content of the exhaust gas.

In a step S16, depending upon the determined setpoint value LD_SP of the degree of ammonia loading of the exhaust gas catalytic converter 23 an actuating signal SIG for an actuator may be determined. The actuating signal may be determined for example by means of a characteristics map or a model calculation, which may be logged for example on an engine test bed. The actuator is one of the actuators, the position of which affects the actual degree of ammonia loading of the exhaust gas catalytic converter 23. The actuator is preferably the urea injection valve 54 and/or the urea valve 52.

In a step S17 a control CTL of the corresponding actuator is effected in order to convert the setpoint value LD_SP of the degree of ammonia loading of the exhaust gas catalytic converter 23.

In a step S18 the second program may be terminated. Preferably, however, the second program is executed regularly during operation of the internal combustion engine.

The first and/or the second program for operating the internal combustion engine 14 may be subdivided into further subprograms or implemented in a higher-level program.

The two programs, which are suitable for implementing the exhaust gas after-treatment of the internal combustion engine 14 particularly effectively, utilize the knowledge that one and the same motor vehicle is regularly driven by the same drivers, who exhibit in each case individual driving behaviors, and/or that the same motor vehicles regularly travel along the same routes.

For example, the recurring run patterns RUN_PAT may be representative of an aggressive driver. In this case, the aggressiveness of the driver refers to the driving style of the driver. If, using the logged recurring run patterns RUN_PAT of the operating variable, the aggressive driver is identified, this means that for example at the beginning of the driving cycle more ammonia should be made available in the exhaust gas catalytic converter 23 since an aggressive driving behavior leads to the production of more nitrous oxides than a defensive driving behavior. The aggressive driving behavior however results in a higher temperature of the exhaust gas catalytic converter 23, this leading to a lower maximum loading of the exhaust gas catalytic converter 23. Because of the lower maximum loading of the exhaust gas catalytic converter 23, however, less ammonia may be stored because otherwise the ammonia breakthrough occurs and leads to annoyance caused by an unpleasant smell. In the case of the aggressive driver, the recurring run patterns RUN_PAT of the operating variable exhibit for example frequent load changes and high temperature jumps, for example during the combustion process.

Aggressive drivers also include drivers who permanently have a high torque requirement. As a result, the temperature of the exhaust gas catalytic converter 23 additionally increases, which particularly in the case of an interim stopping of the vehicle may lead to the ammonia breakthrough since no cooling by the slip stream occurs in the stationary state.

Furthermore, motor vehicles that are operated basically only in urban traffic exhibit special runs of the operating variable and hence also the recurring run patterns RUN_PAT of the operating variable. Such motor vehicles are for example taxis in urban traffic. Upon detection of the motor vehicle that is being used exclusively in urban traffic, it is then possible for example to store a different ammonia characteristics map, on the basis of which depending upon the operating variable the setpoint value LD_SP of the degree of loading is determined.

The two programs are eminently suitable for operating the internal combustion engine 14 if the motor vehicle is a scheduled service bus. In the case of the scheduled service bus, the route that the scheduled service bus has to travel is predefined. The scheduled service bus is required for example repeatedly after the same running period of its driving cycle for example to negotiate a hill, travel along an expressway and/or continuously stop at short intervals at traffic lights or bus stops.

Like the motor vehicle in urban traffic, motor vehicles of commuters also have constantly recurring run patterns RUN_PAT of the operating variable. For example, in the morning after travel at a rather higher speed and with few stops the travelling speed after encountering urban traffic will regularly markedly drop and the driver will stop much more often. Thus, the degree of ammonia loading may be set differently in the morning at the start of the driving cycle than in the morning at the end of the driving cycle. Conversely, in the evening at the start of the driving cycle the degree of ammonia loading may be set to urban traffic and after a defined period of time changed over to long-distance traffic.

If the operating variable comprises the pedal position of the accelerator pedal 27 of the internal combustion engine 14, then for example a kick-down or some other increasing torque requirement of a driver of the motor vehicle may also be detected. In dependence thereon the degree of loading of the exhaust gas catalytic converter 23 may then be increased in anticipation, so that the nitrous oxides that are produced with increasing torque are preferably transformed as effectively as possible. Furthermore, after a thrust phase by means of the actuation of the accelerator pedal or an actuation of the clutch to engage another gear an end of the thrust phase may be detected.

The measures described above bring about a reduction of the consumption of the urea solution and hence an increase of the range of the urea tank 40. The risk of ammonia breakthrough of the exhaust gas catalytic converter 23 is moreover reduced, thereby making it possible to dispense with a blocking catalytic converter for annihilating ammonia in the event of an ammonia breakthrough. This lowers the system costs and avoids secondary reactions that may be caused by the blocking catalytic converter. Furthermore, the nitrous oxides may be converted more effectively as there is always promptly enough ammonia available in the exhaust gas catalytic converter 23.

The anticipatory loading of the exhaust gas catalytic converter 23 may moreover be carried out at operating points, at which the loading of the exhaust gas catalytic converter 23 is particularly advantageous. This applies above all in operating states, in which in the exhaust gas tract 4 temperatures prevail that are high enough to allow the urea solution to hydrolyze into ammonia in the exhaust gas tract 4.

What is claimed is:

1. A method of operating an internal combustion engine of a motor vehicle, comprising the steps of:
during a plurality of driving cycles of the motor vehicle:
logging, in each case, one run of at least one operating variable of the internal combustion engine that is representative of a noxious substance content of an exhaust gas of the internal combustion engine is logged,
analyzing the logged runs with regard to recurring run patters, and
during an actual driving cycle of the motor vehicle:
determining a setpoint value of a degree of ammonia loading of an exhaust gas catalytic converter of the internal combustion engine by using the recurring run patterns,
depending upon the determined setpoint value of the degree of ammonia loading, determining at least one actuating signal for an actuator, the position of which affects an actual degree of ammonia loading of the exhaust gas catalytic converter, and
to convert the determined setpoint value of the degree of ammonia loading of the exhaust gas catalytic converter, controlling the actuator depending upon the actuating signal.

2. The method according to claim 1, wherein the recurring run patterns are used during determination of the setpoint value of the degree of ammonia loading only if a frequency, with which the corresponding recurring run patterns occur in each case in the logged runs, is greater than a preset threshold value.

3. The method according to claim 1, wherein during the actual driving cycle of the motor vehicle the setpoint value of the degree of ammonia loading of the exhaust gas catalytic converter is determined using the recurring run patterns in that
an actual run of the operating variable is determined,
using the recurring run patterns and depending upon the determined actual run of the operating variable a trend, with which the noxious substance content of the exhaust gas is expected to vary, is determined,
depending upon the determined trend the setpoint value of the degree of ammonia loading of the exhaust gas catalytic converter is determined and converted.

4. The method according to claim 3, wherein the setpoint value of the degree of ammonia loading of the exhaust gas catalytic converter is determined and converted in such a way that after conversion of the setpoint value of the degree of ammonia loading of the exhaust gas catalytic converter the exhaust gas catalytic converter is loaded in such a way with ammonia that the nitrous oxides then contained in the exhaust gas may be transformed with the ammonia.

5. The method according to claim 3, wherein the trend is evaluated with a probability value that is representative of the probability that an actual run of the noxious substance content of the exhaust gas will follow the determined trend, and wherein the setpoint value of the degree of ammonia loading of the exhaust gas catalytic converter is determined depending upon the determined trend only if the probability value is greater than a preset second threshold value.

6. An apparatus for operating an internal combustion engine of a motor vehicle, which is operable
during a plurality of driving cycles of the motor vehicle:
to log in each case one run of at least one operating variable of the internal combustion engine that is representative of a noxious substance content of an exhaust gas of the internal combustion engine,
to analyze the logged runs with regard to recurring run patterns, and
during an actual driving cycle of the motor vehicle:
to determine a setpoint value of a degree of ammonia loading of an exhaust gas catalytic converter of the internal combustion engine by using the recurring run patterns,
depending upon the determined setpoint value of the degree of ammonia loading, to determine at least one actuating signal for an actuator, the position of which affects an actual degree of ammonia loading of the exhaust gas catalytic converter, and
to control the actuator depending upon the actuating signal in order to convert the determined setpoint value of the degree of ammonia loading of the exhaust gas catalytic converter.

7. The apparatus according to claim 6, wherein the apparatus is operable to use the recurring run patterns during determination of the setpoint value of the degree of ammonia loading only if a frequency, with which the corresponding recurring run patterns occur in each case in the logged runs, is greater than a preset threshold value.

8. The apparatus according to claim 6, wherein the apparatus is operable to determine, during the actual driving cycle of the motor vehicle, the setpoint value of the degree of ammonia loading of the exhaust gas catalytic converter using the recurring run patterns in that
an actual run of the operating variable is determined,
using the recurring run patterns and depending upon the determined actual run of the operating variable a trend, with which the noxious substance content of the exhaust gas is expected to vary, is determined,
depending upon the determined trend the setpoint value of the degree of ammonia loading of the exhaust gas catalytic converter is determined and converted.

9. The apparatus according to claim 8, wherein the apparatus is operable to determine the setpoint value of the degree of ammonia loading of the exhaust gas catalytic converter and to convert the setpoint value in such a way that after conversion of the setpoint value of the degree of ammonia loading of the exhaust gas catalytic converter the exhaust gas catalytic converter is loaded in such a way with ammonia that the nitrous oxides then contained in the exhaust gas may be transformed with the ammonia.

10. The apparatus according to claim 8, wherein the apparatus is operable to evaluate the trend with a probability value that is representative of the probability that an actual run of the noxious substance content of the exhaust gas will follow the determined trend, and wherein the setpoint value of the degree of ammonia loading of the exhaust gas catalytic converter is determined depending upon the determined trend only if the probability value is greater than a preset second threshold value.

11. An motor vehicle comprising an internal combustion engine and an apparatus which is operable:
during a plurality of driving cycles of the motor vehicle:
to log in each case one run of at least one operating variable of the internal combustion engine that is representative of a noxious substance content of an exhaust gas of the internal combustion engine,
to analyze the logged runs with regard to recurring run patterns, and
during an actual driving cycle of the motor vehicle:
to determine a setpoint value of a degree of ammonia loading of an exhaust gas catalytic converter of the internal combustion engine by using the recurring run patterns,
depending upon the determined setpoint value of the degree of ammonia loading, to determine at least one actuating signal for an actuator, the position of which affects an actual degree of ammonia loading of the exhaust gas catalytic converter, and
to control the actuator depending upon the actuating signal in order to convert the determined setpoint value of the degree of ammonia loading of the exhaust gas catalytic converter.

12. The motor vehicle according to claim 11, wherein the apparatus is operable to use the recurring run patterns during determination of the setpoint value of the degree of ammonia loading only if a frequency, with which the corresponding recurring run patterns occur in each case in the logged runs, is greater than a preset threshold value.

13. The motor vehicle according to claim 11, wherein the apparatus is operable to determine, during the actual driving cycle of the motor vehicle, the setpoint value of the degree of ammonia loading of the exhaust gas catalytic converter using the recurring run patterns in that
an actual run of the operating variable is determined,
using the recurring run patterns and depending upon the determined actual run of the operating variable a trend, with which the noxious substance content of the exhaust gas is expected to vary, is determined,
depending upon the determined trend the setpoint value of the degree of ammonia loading of the exhaust gas catalytic converter is determined and converted.

14. The motor vehicle according to claim 13, wherein the apparatus is operable to determine the setpoint value of the degree of ammonia loading of the exhaust gas catalytic converter and to convert the setpoint value in such a way that after conversion of the setpoint value of the degree of ammonia loading of the exhaust gas catalytic converter the exhaust gas catalytic converter is loaded in such a way with ammonia that the nitrous oxides then contained in the exhaust gas may be transformed with the ammonia.

15. The motor vehicle according to claim 13, wherein the apparatus is operable to evaluate the trend with a probability value that is representative of the probability that an actual run of the noxious substance content of the exhaust gas will follow the determined trend, and wherein the setpoint value of the degree of ammonia loading of the exhaust gas catalytic converter is determined depending upon the determined trend only if the probability value is greater than a preset second threshold value.

16. The motor vehicle according to claim 11, further comprising an exhaust gas after-treatment system associated with an exhaust gas tract .

17. The motor vehicle according to claim 16, wherein the exhaust gas after-treatment system comprises a reducing agent tank for receiving a reducing agent comprising said ammonia, a reducing agent metering valve and a reducing agent pump for supplying reducing agent from the reducing agent tank to the reducing agent metering valve.

18. The motor vehicle according to claim 17, wherein the reducing agent tank preferably comprises a urea tank 40, the reducing agent metering valve comprises a urea injection valve.

19. The motor vehicle according to claim 17, wherein the reducing agent further comprises a complex salt. 6757109

20. The motor vehicle according to claim 17, wherein upstream of the urea injection valve a particulate filter is disposed and downstream of the urea injection valve a mixing apparatus is disposed for mixing the metered urea with exhaust gas in the exhaust gas tract.
